(19) United States
(12) Patent Application Publication
(10) Pub. No.: US 2010/0058393 A1
(43) Pub. Date: Mar. 4, 2010

(54) Switched Digital Video Broadcast Scheduler

(75) Inventor: Raymond C. Bontempi, Jamison, PA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 12/200,418

(22) Filed: Aug. 28, 2008

(51) Int. Cl. G06F 3/00

(52) U.S. Cl. 725/58

(57) ABSTRACT

A method of reducing channel change requests received by a switched network system includes communicating recording schedules from subscriber devices to a broadcast scheduler and creating or modifying a broadcast schedule based on the recording schedules. A system for avoiding message storms within a broadcasting network includes subscriber devices, a broadcast source communicatively coupled to the subscriber devices, and a broadcast scheduler configured to create or modify a broadcast schedule in response to anticipated requests by the subscriber devices such that requests by the subscriber devices are minimized.

### BACKGROUND

Cable and satellite networks can be used to broadcast television programming as well as other data to a population of subscribers. Typically each subscriber will have a set-top box or terminal used to receive the programming and other services available from the network. Some such set-top boxes incorporate a digital video recorder that can be programmed to record programming of interest to each individual subscriber for subsequent playback. Typically, a digital video recorder includes a hard drive on which many hours of television programming can be recorded.

Such networks do, however, have a limited bandwidth over which data can be transmitted. Consequently, it is important that this bandwidth be used as efficiently as possible. A switched digital video broadcast system efficiently utilizes a limited bandwidth communication network by broadcasting only those channels which are currently being viewed or recorded by subscribers.

In a switched digital video broadcast system, to view a channel which is available but not currently being broadcast, a subscriber, or the subscriber's equipment, must transmit a request to a distribution hub. The distribution hub then allocates bandwidth for the requested channel and begins the broadcast of the content.

As noted, a digital video recorder is a common subscriber device that provides automated recording of video content from broadcast systems. The subscriber may enter a schedule for recording which is followed by the digital video recorder in making requests for programs and recording the video data.

However, in a switched digital video broadcast system, the widespread use of digital video recorders can create “message storms” which adversely affect the performance of the broadcast system. A “message storm” occurs when the volume of requests for content being received by the broadcast system exceeds the capability of the system to respond to such messages.

When a large number of digital video recorders have been instructed to record the same program that is scheduled to air in the future, a “message storm” can result when the digital video recorders simultaneously request the desired content at the appointed time from the distribution hub in a switched digital video broadcast system. This “message storm” can severely impair the performance of the broadcast system.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram showing both switched and non-switched telecommunication networks, according to principles described herein.

FIG. 2 is a flow chart showing one illustrative method for a subscriber device to determine if a change request should be sent to the broadcast system, according to principles described herein.

FIG. 3 is a diagram showing an illustrative interchange of data between digital video recorders (DVRs) and a broadcast scheduler in a switched digital video scheme, according to principles described herein.

FIG. 4 is a flowchart showing one illustrative method that could be used by a broadcast scheduler in handling reported DVR schedules, according to principles described herein.

FIG. 5 is a flowchart showing one illustrative decision tree that could be used by a DVR operating in a switched digital video network, according to principles described herein.

FIG. 6 is a diagram showing one illustrative embodiment of a schedule computed by a broadcast scheduler for actual use, according to principles described herein.

Throughout the drawings, identical reference numbers designate similar, but not necessarily identical, elements.

### DETAILED DESCRIPTION

As described briefly above, switched digital video is a method of operating a telecommunications network that utilizes available communication bandwidth in a more efficient manner than non-switched networks. By way of explanation, the following paragraphs will describe some of the differences between switched and non-switched video networks.

One typical non-switched network is a hybrid fiber-coaxial (HFC) network. A HFC network comprises a transport ring, a fiber optic cable connected to the transport ring at a distribution hub, an optical node at the terminal end of the fiber optic cable, and coaxial cable running from the optical node to the individual subscriber locations. This connection between the optical node and the individual subscriber locations is sometimes referred to as “the last mile.”

Each optical node is connected via coaxial cable to a number of subscriber locations, for example 1 to 2000 subscriber locations. Typical HFC networks transmit all available video channels from the optical node through the coaxial cable to each subscriber location. At each subscriber location, the subscriber's equipment may or may not be turned on to display or record video content. Additionally, at each subscriber location, only one or two of the available video channels will be tuned for viewing or recorded while all other available channels are ignored.

Because only a portion of the transmitted content is being used at a given time, the remainder of the network bandwidth is wasted transmitting data that is not viewed or otherwise utilized by subscribers. For this reason, the non-switched network may be consider as inefficiently using the available bandwidth.

In a switched digital video network, the unwatched channels and content need not be transmitted. In a switched digital video network, when a subscriber or the subscriber's equipment is to utilize a particular program in the broadcast schedule, the subscriber equipment sends a channel request signal to the distribution hub. If that channel is not currently being transmitted on the coaxial cable, the distribution hub allocates a new service on a quadrature amplitude modulation (QAM) channel and transmits the new channel to the coaxial cable via the QAM modulator. In this way, only channels which are actually being watched or recorded are transmitted. The resulting increase in efficient use of the bandwidth may allow additional data to be transmitted, more subscribers to be served by a given network, or additional services to be provided by the network.

In order for the broadcasting node or server to know which channels of programming to broadcast in a switched digital video network, two-way communication is necessary between the server and the receiving device, i.e., the subscriber's equipment. A variety of two-way protocols can be used such as Video on Demand, internet communication protocols, or various proprietary schemes. The content of this communication could comprise, for example, a request by the subscriber device to the server for the channel which the subscriber device is programmed or instructed to display or record.

The term “digital video recorder” or “DVR” as used in the specification and appended claims refers to any recording device that can be used to record broadcast video. By way of example and not limitation, the term “DVR” may include personal video recorders, disk drives, personal computers which are capable of video capture and playback, or combinations of software and hardware which are configured to allow video capture.

In switched video networks, a significant problem can occur when a large number of digital video recorders (DVRs) are connected to a switched digital video network and make simultaneous or near-simultaneous requests for a channel of programming to be included in the broadcast over the switched video network.

As noted above, DVRs can be programmed to record a desired channel at a given time. In a switched digital network, the DVR sends a request to the distribution hub for the channel it is programmed to record if the channel is not currently available. As used herein and in the appended claims, a “channel change request” is a message or request sent from a subscriber's equipment, such as a DVR, to a distribution system requesting that a particular program or channel be included in the signal broadcast by the distribution system. In some cases, a channel change request may be sent unnecessarily because the requested channel is already included or to be included in the signal broadcast by the distribution system.

For example, if a substantial number of DVRs are set to begin recording a channel or channels at the same time, a large number of channel change requests could be simultaneously sent upstream to the broadcast server. For example, during popular sports events, such as the Super Bowl, World Series or World Cup, a great number of DVRs may be programmed to record the same programming at the same time.

A “message storm” can also occur even if the DVRs are recording different programs, but the recording is to begin at the same time such that a volume of requests, albeit for different channels, are sent by the DVR population at the same time. For example, high demand times could be during the top and bottom of the hour, when programming across a plurality of channels is ending and new programming is beginning.

As programs end, viewers naturally search for and change programs, thereby resulting in a greater volume of change requests. Normally the channel changes made by human operators are statistically separated such that a “message storm” does not result. However, when recordings are scheduled through DVRs it is more likely that these channel changes may occur closer to the same time.

As described above, this large number of requests may result in a message storm at the server end, causing undesirable network performance. A message storm occurs when the number of messages received by a server exceeds the server's ability to handle and respond to the messages. The severity of a message storm can be measured by the amount of information, in the form of channel change requests, sent in a given time period. If this exceeds the server's ability to respond, the server may crash or slow considerably.

A broadcast scheduler, as described herein, can mitigate messaging storm problems caused by heavily scheduled DVR recordings. According to one exemplary embodiment, each DVR in the network transmits a recording schedule to an upstream server. This recording schedule may include the date, time, and channel of each scheduled recording on that DVR. If updates are made to the DVR's recording schedule, these changes may also be sent to the server.

On the server, a broadcast schedule application correlates all of the recording schedules from the population of DVRs being served and places all channels that are scheduled to be recorded by the DVRs on the server's own broadcasting schedule. According to one illustrative embodiment, the broadcast scheduler calculates the number of channel change requests that the server is likely to receive and, if possible, creates a broadcasting schedule that will reduce peak volumes of channel change requests below a predetermined threshold.

The broadcast schedule is published to the downstream DVRs which then do not send channel change requests for the scheduled programs. By adding commonly recorded programs to the server broadcasting schedule, the number of channel change requests received by the server are reduced, particularly during specific times that problematic numbers of messages may be sent.

In one illustrative embodiment, the DVRs may be restricted from sending any message requests at all. Rather, the broadcast scheduler alone determines what will be broadcast based at least in part on the recoding schedules submitted by the population of DVRs. In a second illustrative embodiment, the DVR receives the broadcast schedule and searches the broadcast schedule for the entries in its own recording schedule. The DVR will then only send a request for a new channel to be added to the broadcast schedule if it has an entry in its recording schedule that is not in the broadcast schedule.

In various embodiments, the broadcast schedule does not fill the entire bandwidth of the system. Some bandwidth is reserved for live viewers who wish to select programming to watch live, for example, using an Electronic Program Guide (EPG). If this selected programming is not already in the broadcast schedule, the reserved bandwidth is available to provide that programming to the live viewer. Consequently, there may be a particular amount of bandwidth reserved for such live viewers. However, not all of this bandwidth may be used if fewer than expected live viewers use the system at a particular time. Where there is unused bandwidth allocated for live viewers, the system can choose to use some or all of that bandwidth to fill additional requests from DVRs that the system was not initially able to accommodate due to a lack of bandwidth (e.g. those change requests for programming not in the initial broadcast schedule).

As an alternative or supplemental approach, the broadcast scheduler could begin the broadcasting of the scheduled channel a few minutes before the actual schedule. This would again suppress channel change requests as the channel will already be available when the DVRs start recording.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

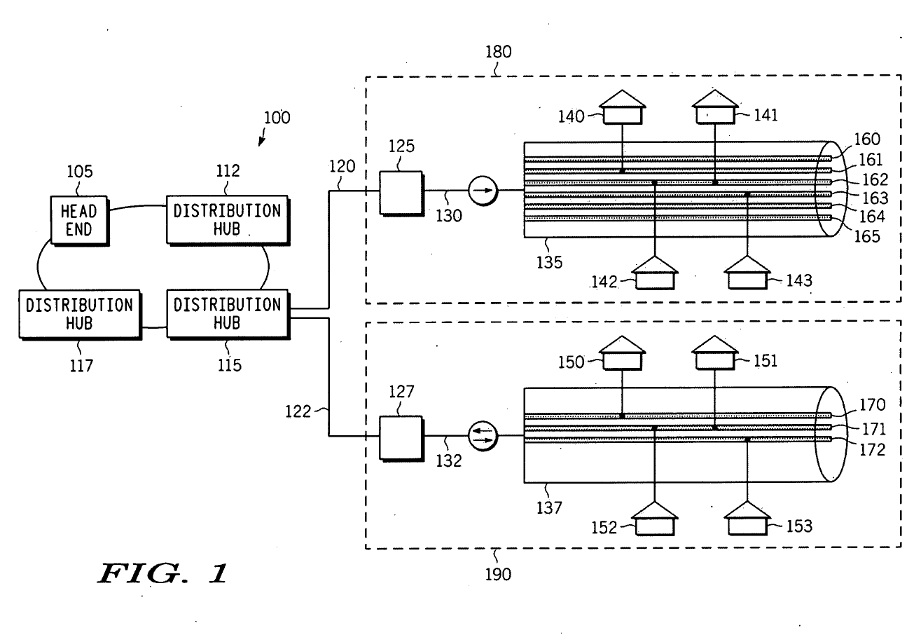

FIG. 1 is an illustrative diagram showing both switched and non-switched telecommunication networks. A typical telecommunications network comprises a transport ring (100). The transport ring (100) typically includes a head end (105) and a plurality of distribution hubs (112, 115, 117). From the distribution hubs, individual fiber optic lines (120, 122) can take data to various locations. The fiber optic lines (120, 122) have a high bandwidth and can rapidly transmit a variety of data. However, these fiber optic lines (120, 122) are expensive to install. At the location in the system where it becomes economically unfeasible to continue with fiber optic lines (120, 122), an optical node (125, 127) converts the optical signal into an electrical signal which is then distributed through a coaxial cable (130, 132) to the individual subscriber locations.

In a non-switched network (180), the distribution hub sends all of the available subscriber data, e.g., channels of television programming, through the fiber optic line (120) to the optical node (125) and through the coaxial cable (130) to individual subscriber locations (140 through 143). The dataflow through this communication channel is one way, going from the distribution hub to the individual subscribers (140 through 143). The various channels of data are represented by horizontal bars (160 through 165). The individual subscribers (140 through 143) can then choose from the available channels (160 through 165) the content they desire to utilize.

According to one exemplary embodiment, a first subscriber (140) tunes a first channel (161), while other subscribers (141, 142) tune to second channel (162). A fourth subscriber (143) tunes a third channel (163). However, as can be seen from the diagram in FIG. 1, several channels (160, 165) are piped through the communication network without being utilized. Because only a small fraction of the transmitted content is actually being tuned, e.g., watched or recorded, at a given time, a large portion of the network bandwidth is wasted in transmitting data that is not viewed or otherwise utilized by subscribers. This inefficient usage of channel bandwidth can result in higher costs, lower quality service, a reduction in the amount and variety of content which can be transmitted, etc.

As described above, in a switched digital video network (190), the unwatched channels and content need not be sent. Similar to the non-switched network, a fiber optic cable (122) makes a connection between the distribution hub (115) and an optical node (127). The optical node (127) converts the optical signal into an electrical impulse train which travels through the coaxial cable (132) to the various subscribers (150 through 153). However, unlike the non-switched distribution network (180), the switched network (190) allows for two-way communication between the subscribers (150 through 153) and the distribution hub (115). Specifically, the switched network (190) allows the individual subscribers (150 through 153) to make requests for programming or channels they desire to watch, record, or utilize. In one embodiment, the subscriber equipment sends a channel change request upstream to a server within the distribution hub. If the requested channel is not currently being transmitted on the coaxial cable, the distribution hub allocates a new quadrature amplitude modulation (QAM) channel and transmits the requested data on the new channel. The distribution hub (115) only sends the channels which are currently being utilized (170, 171, 172) to the subscribers (150 through 153). In this way, only channels which are being watched or recorded are transmitted. The resulting improvement in the efficient use of the bandwidth may allow additional data to be transmitted, more subscribers to be served by a given network, or additional services to be provided by the network.

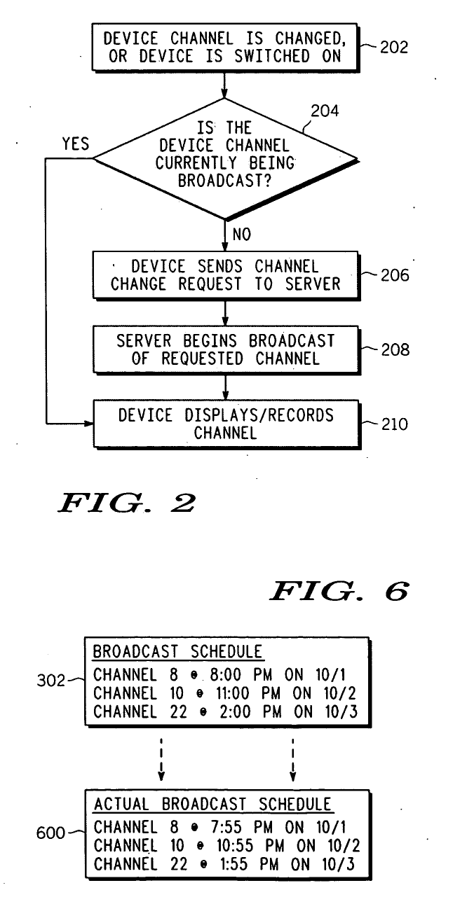

FIG. 2 is a flow diagram showing one illustrative method which could be used by a subscriber device to request content within a switched digital system. When a subscriber device in a switched digital system is switched on or the channel it is receiving is changed (step 202), the subscriber device will first check to see if the channel it has been instructed to tune is currently being broadcast (determination 204). If the channel is not being broadcast, the subscriber device sends a channel change request to the server (step 206).

The communication between the subscriber device and the distribution hub can be handled in a variety of ways. According to one exemplary embodiment, communication protocols used on the Internet may be adapted for communication between the subscriber device and the distribution hub. According to an alternative embodiment, a variety of proprietary schemes allocate specific frequencies to pass messages back to the distribution hub (115, FIG. 1). In some situations, such as cable television systems, all digital television users in a subscription group (190, FIG. 1) are required to have devices that are capable of communicating to the distribution hub (115, FIG. 1).

The server responds by including the requested channel (step 208) in the broadcast signal. The subscriber device can then receive the content or programming of the requested channel (step 210).

In some cases, however, the requested channel may already be included in the broadcast signal. If the subscriber device checks for the requested channel (determination 204) in the broadcast signal and that channel is already being broadcast, the subscriber device will simply begin receiving the channel (210) without sending a channel change request.

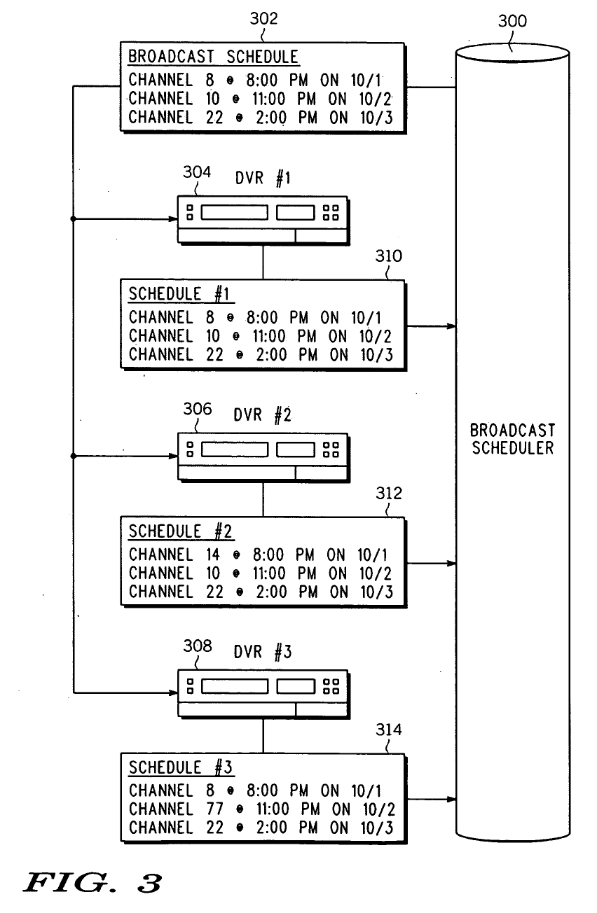

FIG. 3 is a diagram showing an illustrative interchange of data between DVRs (304, 306, 308) and a broadcast scheduler (300) in a switched digital network. The DVRs (304, 306, 308) represent receiving devices at subscriber locations (150 through 153, FIG. 1) which report their recording schedules (310, 312, 314) to the local broadcast scheduler (300). The broadcast scheduler (300) may be, for example, an application running on a broadcast server or another server. The broadcast server may be a component with the transport ring (100, FIG. 1). By way of example and not limitation, the broadcast server could reside within a head end (105, FIG. 1) or within a distribution hub (115, FIG. 1).

As will be described in more detail below, the broadcast scheduler (300) correlates the reported recording schedules (310, 312, 314) and creates a broadcast schedule (302) that includes programs scheduled for recording by the DVR population (304, 306, 308), with emphasis on programs that are heavily scheduled for recording. Heavily scheduled programs may be identified, for example, by comparing the number of reported DVR recording schedules that including a setting to record the program to a previously defined threshold number. For illustrative purposes, the threshold number in this example may be two, such that, when two or more DVRs are scheduled to record the same program, the threshold number will be exceed and that program will be considered a heavily scheduled program and included in the schedule of programming to be transmitted in the broadcast signal. As will be apparent to one skilled in the art, this threshold number may vary from one to more than two as best suits a particular network.

As shown in the example of FIG. 3, all three DVR schedules (310, 312, 314) include channel 22 at 2 PM on October 3^{rd}. This broadcast time period for this channel meets the requirement for being heavily scheduled and is therefore included in the broadcast schedule (302) created by the scheduler (300). By this same method, channel 8 at 8 PM on October 1^{st} and channel 10 at 11 PM on October 2^{nd} are also included in the broadcast schedule (302). The scheduled channel 14 (312) and channel 77 (314) recordings are not included in the broadcast schedule (302) because they do not meet the threshold requirement. Although, in some embodiments, any channel in any of the DVR recording schedules may be added to the broadcast schedule (302).

It should also be noted that if the majority or large groups of viewers or DVRs are all watching one or a small number of very popular programs, there may be a significant amount of unused bandwidth remaining because many or most subscribers are accessing only, e.g., one or two programs. This additional, unused bandwidth can be made available to fill other DVR requests, for example, for much less popular programs. Thus, even though a high number of users are accessing programming, because a relatively smaller number of programs are being requested, additional, less popular programs that might otherwise not have been included in the broadcast schedule can be.

Once the broadcast schedule (302) is determined, it will then be made available to the DVRs (304, 306, 308). For example, the schedule (302) may be posted for electronic access by the DVRs (304, 306, 308). Alternatively, the schedule (302) can be sent to the DVRs over the network to be stored in each DVR memory. Once the DVRs have access to the broadcast schedule (302) which indicates which channels will be included in the broadcast signal of the network at each given time period, the DVRs (304, 306, 308) then suppress channel change requests for the channels at times already included in the broadcast schedule (302).

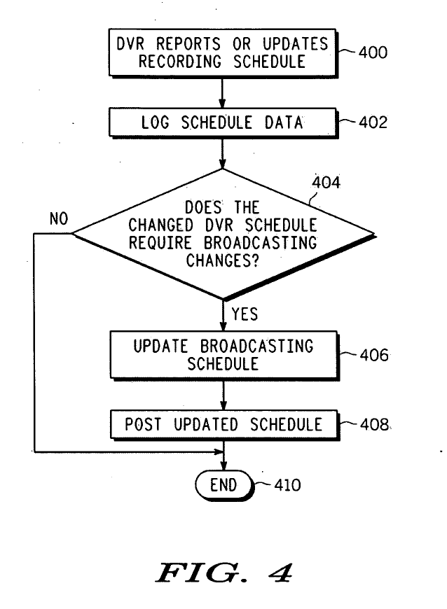

FIG. 4 is a flowchart showing one illustrative method that could be used by a broadcast scheduler in handling reported DVR recording schedules. When a DVR reports its recording schedule or updates an already reported schedule (step 400) to the broadcast scheduler application (300, FIG. 3), the broadcast scheduler (300, FIG. 3) first logs the information (step 402) and then evaluates whether the new schedule information requires a change of the broadcasting schedule (determination 404).

According to one illustrative embodiment, this is done by comparing the number of DVR recording schedules that include a specific program to the previously discussed threshold number. However, other methods of analyzing the reported recording schedules could be used to determine which programs to include in the broadcast schedule.

The broadcast schedule could be periodically updated as a result of new scheduling information received from the subscriber devices. Programs that now meet the definition of a heavily scheduled program will be added to the broadcast schedule. Those that lose their heavily scheduled status as a result of the new information will be removed.

If the new information requires a schedule change, the change is made (step 406) and the new broadcast schedule is made available (step 408). The scheduler's response to the update is then finished (step 410). If the new information does not require a broadcasting change (determination 404) the new information is simply logged but no change to the broadcast schedule is made and the response to the update is finished (step 410).

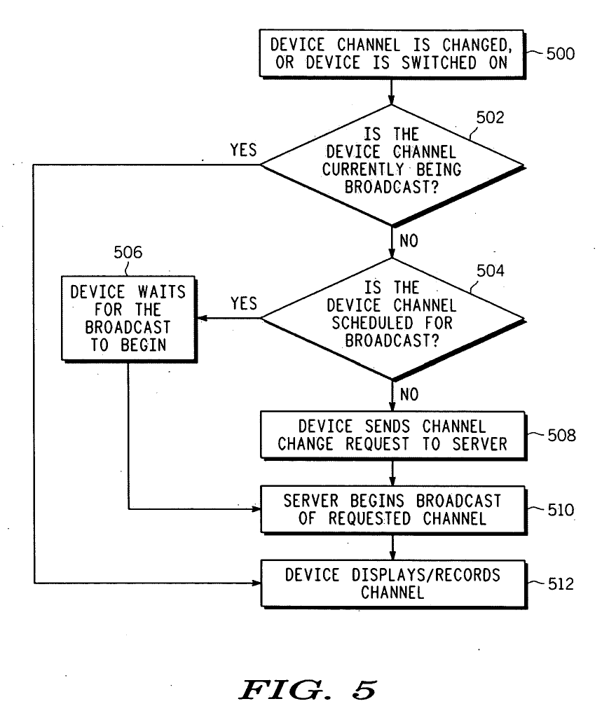

FIG. 5 is a flowchart showing one illustrative method that could be used by a DVR operating in a switched network environment to determine if a content request should be sent to the distribution hub. According to one illustrative embodiment, when the channel of the DVR is changed or the device is turned on (step 500) the DVR determines whether the indicated channel to be received is currently being broadcast (determination 502). A DVR channel change message could thus be due to either a scheduled recording or to a direct user selection.

If the indicated channel is already being broadcast, the device simply receives the desired channel (step 512). However, if the channel is not currently being broadcast the DVR will then check to see if the channel is scheduled for broadcast (step 504) within the desired time period. This is done with reference to the broadcast schedule (302, FIG. 3), described above, which has been made available to the DVR.

If the channel is not scheduled for broadcast, the DVR will send a channel change request to the server (step 508). The server will then begin the broadcast of the requested channel (step 510), and the DVR receives the requested channel (step 512).

If the channel is scheduled for broadcast within the desired time period, the device will wait for the broadcast to begin (step 506). In most situations, the DVR will only be required to wait for a minimal period of time because the channel is already configured to be available at a predetermined time. When the server begins the broadcast (step 510), the DVR can then receive the channel as desired (step 512).

In this setup, the DVRs will only send channel change requests when the desired channel is currently not being broadcast and the server is not scheduled to broadcast the desired channel within the time period the desired channel is to be received by the DVR. In all other situations, the channel change request will be suppressed, thereby limiting the total number of requests the server receives. In cases when requests are sent, there will only be a relatively small number of DVRs sending requests at the same time, thereby reducing the likelihood that a message storm will occur.

FIG. 6 is a diagram showing one illustrative embodiment of a schedule computed by the broadcast scheduler for actual use. According to this embodiment, the server could begin the broadcast of the scheduled channels a few minutes before those channels are scheduled to be recorded by the population of DVRs. As described herein, this method helps control the number of channel change requests received by the server at one time and can be used in addition to the previously discussed methods, or can be used as an alternative to posting the broadcast schedule (302, FIG. 3) to the DVRs.

FIG. 6 shows the actual broadcast schedule (600) that is compiled from the DVR recording schedules (302, FIG. 3). When this method is combined with the previously described scheduler, no change would be made except that the actual broadcast time would be modified as shown in FIG. 6. For example, the published broadcast schedule (302) lists a program that is scheduled to be broadcast on channel 8 at 8:00 PM on October 1^{st}. The actual broadcast schedule (600) shows that the broadcast of the program will begin at 7:55 PM, rather than at 8:00 PM.

By advancing the starting time of the broadcast, when DVRs begin to come online to determine if a channel change request is required to receive the desired programming, the program is already being broadcast. This would be beneficial because any DVR that is scheduled to record the program will not need to send a channel change request as the desired channel is already being broadcast.

The content that is broadcast between the actual start time of 7:55 PM and the scheduled start time of 8:00 PM could comprise “filler” content such as advertising or teasers, rather than an actual program. If the illustrative method shown in FIG. 6 is used as an alternative to posting the schedule (302, FIG. 3) to the DVRs, the schedule (302, FIG. 3) would still be calculated, but it would not be sent to the DVRs.

In sum, a broadcast scheduler can be used in conjunction with a switched digital network to more intelligently manage communication between subscriber devices and the switched digital network. The quantity of channel change request messages received by the switched digital network from the subscriber devices during peak times can be reduced by statistically separating the communications and by communicating recording schedules in advance.

The communications can be statistically separated by initiating communication when a subscriber device is turned on, or when a channel is changed. The subscriber device can then communicate its recording schedule and any changes made to that schedule. The switched digital network receives the scheduling data or transmission requests. Using information extracted from the scheduling data allows the switched digital network to intelligently modify a broadcast schedule to include channels that are in the highest demand.

The subscriber devices receive the broadcast schedule and do not request channels that are included in the broadcast schedule. In this manner, the number of channel change requests received by the switched digital system is reduced.

Additionally, the broadcast of the actual content can begin earlier than scheduled. When the recording or display timer within the subscriber device activates the subscriber device, the broadcast of the required channel is already underway, thereby preemptively eliminating the need for a channel change request to be sent to the distribution hub.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of reducing channel change requests received by a switched network system comprising:
communicating recording schedules from subscriber devices to a broadcast scheduler; and
creating or modifying a broadcast schedule based on said recording schedules.

2. The method of claim 1, further comprising communicating said broadcast schedule to said subscriber devices such that channel change requests are minimized.

3. The method of claim 2, wherein said communicating said broadcast schedule comprises transmitting said broadcast schedule to said subscriber devices over said switched network.

4. The method of claim 2, wherein said communicating said broadcast schedule comprises posting said broadcast schedule in a location that is accessible to said subscriber devices.

5. The method of claim 2, wherein said communicating said broadcast schedule comprises transmitting said broadcast schedule to said subscriber devices and storing said broadcast schedule in a memory contained within each said subscriber device.

6. The method of claim 1, wherein said communicating said recording schedules is performed when a channel is changed on a said subscriber device or when a said subscriber device is switched on.

7. The method of claim 1, wherein said creating or modifying said broadcast schedule based on said recording or viewing schedules comprises an addition of programs that meet a threshold requirement to said broadcasting schedule.

8. The method of claim 1, wherein said creating or modifying a broadcast schedule further comprises including in said broadcast schedule any channel and corresponding time listed in said recording schedules.

9. The method of claim 1, wherein said creating or modifying a broadcast schedule further comprises updating said broadcast schedule in response to changes in said recording schedules communicated from said subscriber devices to said broadcast scheduler.

10. The method of claim 1, further comprising, based on said broadcast schedule derived from said recording schedules, beginning to broadcast a program prior to said subscriber devices requesting or beginning to record said program.

11. A method of reducing channel change requests received by a switched network system comprising:
communicating recording schedules from subscriber devices to a broadcast scheduler application, said broadcast scheduler application residing on a server within a distribution hub, said distribution hub being communicatively connected through a transport ring to a head end, said head end broadcasting a plurality of different programs to said distribution hub;
creating or modifying a broadcast schedule, said broadcast schedule based on said recording schedules; programs within said recording schedules that exceed a threshold requirement being added to said broadcast schedule, said broadcasting schedule comprising a subset of programs communicated by said head end to said distribution hub, said broadcasting schedule further comprising information identifying said programs and times at which said programs will be broadcast.

12. The method of claim 11, further comprising communicating said broadcast schedule to said subscriber devices such that channel change requests are minimized.

13. A system for avoiding message storms within a broadcasting network comprising:
subscriber devices comprising a subscriber group;
a broadcast source, said broadcast source being communicatively coupled to said subscriber devices such that said subscriber devices receive data transmitted by said broadcast source;
said subscriber devices making requests to said broadcast source for data available but not currently included within said data transmitted by said broadcast source;
a broadcast scheduler configured to create or modify a broadcast schedule of data transmitted by said broadcast source in response to anticipated requests by said subscriber devices such that said requests are minimized.

14. The system of claim 13, wherein said subscriber devices comprise data recorders; said data recorders being configured to record data available from said broadcast source; said data recorders requesting data available from said broadcast source but not currently being transmitted by said broadcast source.

15. The system of claim 14, wherein said data recorders receive and store said data according to recording schedules, said data recorders being configured to transmit said recording schedules to said broadcast scheduler.

16. The system of claim 15, wherein said broadcast scheduler is configured to aggregate and analyze said recording schedules, said broadcast scheduler being further configured to add data to said broadcast schedule based on said recording schedules such that said requests are minimized.

17. The system of claim 16, wherein said data recorders are digital video recorders.

18. The system of claim 13, wherein said broadcast source is a switched digital broadcast network comprising a head end, a transport ring, and a distribution hub; said transport ring connecting said head end to said distribution hub; said distribution hub being connected to one or more subscriber groups.

19. The system of claim 18, wherein said subscriber devices are configured to transmit a recording schedule to said broadcast scheduler, said broadcast scheduler residing within said distribution hub.

20. The system of claim 19, wherein said broadcast scheduler creates or modifies a broadcast schedule to accommodate said recording schedules of said subscriber devices such that said requests are minimized.
